(19) United States
(12) Patent Application Publication
(10) Pub. No.: US 2017/0104441 A1
(43) Pub. Date: Apr. 13, 2017

(54) PORTABLE POWER SUPPLY UNIT

(71) Applicant: MARK CARLTON SWAN, TINGALPA (AU)

(72) Inventor: MARK CARLTON SWAN, TINGALPA (AU)

(21) Appl. No.: 15/287,848

(22) Filed: Oct. 7, 2016

(30) Foreign Application Priority Data
Oct. 7, 2015 (AU) 2015238835

(51) Int. Cl. H02S 10/40; H02S 30/20

(52) U.S. Cl. CPC H02S 10/40; H02S 30/20

(57) ABSTRACT

A transportable power supply unit is disclosed comprising a load carrying support and an electrical storage arrangement on the support. At least two solar panels are mounted on the load carrying support, each of which is interchangeable between a retracted configuration and a deployed configuration. The load carrying support comprises a base and a rectangular support frame projecting up above the base having four sides. In some forms the unit further includes a post mounted on the base that is extendible between a collapsed configuration for transport and an extended configuration projecting above the support frame. A security camera may be mounted on an upper end of the post.

### FIELD

This disclosure relates to a transportable power supply unit.

This disclosure relates particularly but not exclusively to a transportable power supply unit capable of being transported to and being set up in a remote location. It will therefore be convenient to hereinafter describe the disclosure with reference to this example application. However at the same time it must be recognized that the disclosure is capable of broader application. For example the power supply unit could also be used in a domestic or industrial environment. It could also be used in an urban or built up location rather than a remote location.

### DEFINITION

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

### BACKGROUND

It may be difficult to obtain a source of power in a remote area where there is no access to mains power. For example valuable assets may often be located in a remote region, e.g. for mining or construction activities, or for military purposes. Very often it is not practical to secure such locations with fencing because the area is remote and/or the need for security is temporary. In such environments it is often desirable to have some basic security in place to resist damage to such assets by providing security cameras for carrying out surveillance of the area. It may also be desirable to provide lighting in these areas to illuminate the assets and resist theft. However it is necessary to have a power supply to energize cameras and lights to provide these resources.

Further in many areas it may be difficult to obtain electrical power after natural disasters and the like have occurred because of power outages. Some parts of Australia are prone to natural disasters such as hurricanes and cyclones. Often power supply is interrupted when these natural disasters occur. This can be very disruptive because many modern contrivances rely on power to function effectively. Portable generators may provide some power in these environments and situations. However these portable generators do not provide an elegant solution. For example they do not provide any accessories that might be useful to utilize electrical power that is generated.

### SUMMARY OF THE DISCLOSURE

Applicant has recognized that it would be useful to provide power in a remote location. Applicant also recognized that it would be useful to provide some utilities that utilize electrical power in a remote location.

According to one aspect of the disclosure there is provided a transportable power supply unit, comprising:

a load carrying support
an electrical storage arrangement on the load carrying support; and
at least two solar panels operatively mounted on the load carrying support that are operatively connected to the electrical storage arrangement, where each solar panel is interchangeable between a retracted configuration for transport and a deployed configuration for receiving solar energy.

The portable electrical storage arrangement and battery pack may produce AC or DC power.

Further the portable electrical storage arrangement may include a solar regulator or inverter for converting the solar energy to electrical energy which is then fed into the battery packs.

The load carrying support may include a base, and a support frame projecting up above the base having a plurality of sides. The base may have an upward facing load support surface and the support frame may have a top joining all the sides.

The support frame may be in the form of a three dimensional rectangular frame having four sides.

Each solar panel may be mounted on the support frame and extend across one side of the frame. The support frame may be bolted onto the base to provide high strength and rigidity.

Each solar panel may be arranged in the same plane as its associated side of the support frame in the retracted configuration, and each panel may be inclined outward relative to the associated side of the frame in the deployed configuration.

Each panel may have an inner end pivotally mounted to the support frame and an outer end that is displaced outward relative to the support frame in the deployed configuration to enhance its collection of solar energy.

Further each solar panel may include a panel support arrangement for supporting the solar panel on the support frame in the outwardly extending deployed configuration, and the panel support arrangement may comprise one or more support arms extending between the support frame and the associated solar panel.

In one embodiment in accordance with the disclosure the unit has two solar panels and the solar panels are arranged on opposing sides of the support frame. In another embodiment in accordance with the disclosure the unit has four solar panels on four sides of a rectangular support frame.

The solar panels may be arranged in the deployed configuration to provide optimal solar array positioning so as to maximize collection of solar energy. The panel support arrangement may have features to accomplish this.

The transportable power supply unit may further include at least two stabilizer legs mounted on the load carrying support for stabilizing the support in position on a support surface when the solar panels are in the deployed configuration.

Each support leg may be interchangeable between a stowed configuration in which the leg is folded up against the support frame and a deployed configuration in which the leg projects away from the support frame and onto the support surface.

The stabilizer legs may fold down and out when the solar panels are deployed and may also include a foot that that is configured to grip a support surface, e.g. the ground.

The transportable power supply unit may further include a post that is mounted on the base and projects upward therefrom.

The post may be extendible, e.g. in a telescopic fashion, between a collapsed configuration for transport in which it is received within the support frame and an extended configuration in which it projects upward above the support frame. Typically the post will be retracted for road transport to a deployment location and extended into the extended configuration when the unit is deployed and the solar panels are moved to their deployed configuration.

The transportable power unit may include at least one camera mounted on the post for recording visual images within its field of view. The camera may be a digital camera recording moving pictures or video.

Alternatively the transportable power supply unit may further include at least one light mounted on the post for illuminating an area for surveillance.

The base may be formed by a pallet, and the pallet may have lifter engaging formations for operatively engaging a lifter for generally handling the power supply unit and lifting and lowering the power supply unit.

The pallet may be made of aluminum plates which have been laser cut. Lifter engagement formations in the form of large fork tine slots may be cut in the sides of the pallet to enable quick and easy handling of the power supply unit with a forklift truck.

The electrical storage arrangement may be portable and may comprise at least one battery pack mounted on the base that is electrically connected to the solar regulator and thereby the solar panels.

The transportable power supply unit may include an electrical power board mounted on the load carrying support that is electrically connected to the electrical storage arrangement, and the electrical power board may have a plurality of power sockets thereon into which electrical devices can be plugged.

The transportable power supply unit may further include a plurality of cell phone chargers mounted on the load carrying support that are electrically connected to the electrical storage arrangement. The plurality of cell phone chargers may be incorporated in a bank of cell phone lockers having security features that enable them to be locked by a user.

The transportable power supply unit may further include a unit communications arrangement for enabling an operator to monitor the unit from a location remote from the unit using a wireless network. The unit communications arrangement may further permit an operator to control the power supply unit from a remote location.

The transportable power supply unit may further include a road trailer having a deck and mounted on wheels, and the load carrying support may be positioned on the deck of the trailer.

The transportable power supply unit may include a water filter for filtering water to produce filtered water and a water pump for driving water through the filter.

The filter may be mounted on the load carrying support and the water pump may also be mounted on the load carrying support.

The water pump may be operatively connected to the electrical storage arrangement to provide electrical energy to drive the pump.

The filter may be a cartridge type filter and maybe of the type suitable for filtering drinking water or swimming pool water.

In particular the filter and water pump may be mounted on the base and the water pump and water filter may be sized and configured to be received within spaced defined by the support frame whereby to facilitate transport and handling of the unit.

The unit having a water filter may be suitable for use in generating clean or potable water from river or brackish water in a civil emergency. The unit is self-contained and is not dependent on external electrical power as the electrical energy to drive the pump is generated by the solar panels.

According to another aspect of the disclosure there is provided a transportable power supply unit, comprising:

a trailer mounted on wheels;
a load carrying support mounted on the trailer or formed by the trailer;
an electrical storage arrangement on the load carrying support; and at least two solar panels operatively mounted on the load carrying support that are operatively connected to the electrical storage arrangement, each solar panel being interchangeable between a retracted configuration for transport and a deployed configuration for receiving solar energy.

The transportable power supply unit may have any one or more of the optional features of the power supply unit defined in the preceding aspect of the disclosure.

According to yet another aspect of the disclosure there is provided a transportable power supply unit, comprising:

a load carrying support; and
an electrical storage arrangement on the load carrying support.

The electrical storage arrangement may comprise one or more battery packs that are mounted on the support. Further each battery pack in turn may include one or more batteries that are purchased off the shelf.

The transportable power supply unit may further include at least one solar panel mounted on the load carrying support that is operatively connected to said electrical storage arrangement.

The transportable power supply unit may include at least two solar panels operatively mounted on the load carrying support, e.g. two to four solar panels.

Each solar panel may be interchangeable between a retracted configuration for storage and/or transport and a deployed configuration for collecting or receiving solar energy.

The load carrying support may include a base and the base may be substantially rectangular, e.g. square rectangular.

The base may have an upward facing load support surface and the load carrying support surface may be substantially planar.

The load carrying support may further include a support frame projecting up above the base having a plurality of sides and a top. Conveniently the support frame may be in the form of a three dimensional rectangular frame having four sides. The support frame may be broadly co-extensive with the horizontal extent of the base such that the sides of the support frame broadly correspond with sides of the base.

Each solar panel discussed above may be mounted on the support frame extending across one side of the frame.

For example each solar panel may be arranged in the same plane as its associated side of the frame when in the retracted configuration, and each panel may be inclined outward relative to the associated side when in the deployed configuration.

Each solar panel may include a support arrangement for supporting the solar panel on the support frame in the outwardly extending deployed configurations. Optionally the support arrangement may include one or more support arms extending between the support frame and the solar panel in the deployed configuration.

The power supply unit may further include at least two stabilizer legs mounted on the load carrying support for stabilizing the support in position on a support surface.

Each support leg may be interchangeable between a stowed configuration in which it is folded up against the support frame and a deployed configuration in which the leg projects away from the support frame and onto the support surface, e.g. such as the ground, at a point spaced from the support frame.

Each panel may have an inner end pivotally or pivotably mounted to the frame and an outer end that is displaced outward relative to the frame and oriented so as to enhance its collection of solar energy in the deployed configuration.

The transportable power supply unit may include a post mounted on the base.

The post may be extendible between a collapsed configuration for transport in which it is received within the support frame and an extended configuration in which it projects upward above the support frame.

The transportable power supply unit may include at least one camera for recording visual images within its field of view and the camera may be mounted directly or indirectly on the load carrying support. Optionally the power supply unit may include two or more cameras mounted directly on the post, e.g. towards an upper end thereof.

The camera may be a digital camera recording moving pictures or video.

The transportable power supply unit may further include at least one light for providing light illumination, e.g. in a remote area, mounted directly or indirectly on the load carrying support. Optionally the power supply unit may have two or more lights and the lights may be LED lights. Further said at least one light may be mounted on the post, e.g. towards an operatively upper end thereof.

The transportable power supply unit may include a power board on the load carrying support that is electrically connected to the electrical storage arrangement.

The power board may have a plurality of power sockets thereon into which electrical devices can be plugged to energize or charge the devices. Optionally the power sockets may provide electrical power at the same voltage as domestic mains supply.

The transportable power supply unit may further include a plurality of cell phone chargers on the load carrying support for charging cell phones that are connected thereto.

The plurality of cell phone chargers may comprise a bank of cell phone lockers each of which has a cell phone charger therein.

Preferably but not essentially the cell phone lockers are able to be locked by a user when they leave their phone for charging and unlocked when the user returns to retrieve their phone.

The power supply unit may include a communications arrangement for enabling an operator to monitor the unit remotely.

Optionally the communications arrangement may also permit an operator to control the power supply unit from a remote location.

The communications arrangement may include hardware mounted on the load carrying support for enabling an operator to communicate with the unit from a remote location using wireless networks. The wireless networks may include mobile telephone networks such as 3G and 4G networks.

The base of the load carrying support may be in the form of a pallet.

The pallets may be formed from a metallic material e.g. aluminum, to make them strong and durable.

Optionally the base may be formed by two or more pallets operatively attached to each other to form a correspondingly larger base than would be formed by a single pallet.

The base, e.g. in the form of a pallet, may further include lifter engaging formations for operatively engaging a lifter for lifting and lowering the transportable power supply unit and generally handling the device and moving it around.

A pallet has certain standard properties relating to its size and strength that make it easy to transport from one place to another. This makes it easy and convenient to transport the power unit to a remote geographic location where it is required using existing transport vehicles and infrastructure.

In one form the lifter will be a forklift truck and the lifter engaging formations may be receptacles that are sized and configured to receive forklifts from a forklift truck and then lifting the power unit. The lifter engagement formations for receiving the forks of a forklift are standard formations on a pallet.

According to yet another aspect of the disclosure there is provided a transportable power supply unit for providing electrical power, including:

a support;
an electrical storage arrangement on the support; and
a plurality of power sockets electrically connected to the electrical storage arrangement and mounted on the support for enabling people to charge electrical devices by plugging them into the power sockets.

Optionally the support may be a load carrying support.

The power sockets may provide electrical power at a mains voltage, e.g. in the range of 200 to 250 volts.

According to yet another aspect of the disclosure there is provided a transportable power supply unit for providing electrical power, including:

a support;
an electrical storage arrangement on the load carrying support; and
a plurality of cell phone chargers for charging cell phones mounted on the support, wherein each cell phone charger is electrically connected to the electrical storage arrangement to provide electrical charging to the charger.

Optionally the support may be a load carrying support.

The plurality of cell phone charging stations may comprise a bank of cell phone lockers, each of which has a charger for charging a cell phone. The bank of cell phone lockers may provide from twenty to fifty cell phone lockers.

The support of the power unit may comprise a base and a support frame mounted on the base and projecting up therefrom. The bank of cell phone lockers may be mounted on the support frame.

The electrical storage arrangement may comprise at least one battery pack mounted on the base, e.g. two battery packs mounted on the base.

The battery packs may be arranged along each of opposite sides of the base.

The bank of cell phone lockers may be mounted on the support frame, e.g. at a height above the battery packs.

Each cell phone locker may have a container that can be opened to insert a cell phone and closed to enclose the cell phone in the container. Further the cell phone locker may be capable of being locked when closed to resist unauthorized removal of a cell phone within the container.

The bank of cell phone lockers may have a user interface for enabling each user of a locker to securely lock their cell phone in a cell phone locker and then retrieve the cell phone once it is charged.

The user interface may comprise a key pad and a display screen which enables a user to key in a code for their locker to enable them to lock and then unlock their locker.

Instead each cell phone locker may have a combination lock which can be set by a user when they leave their cell phone within the locker.

The disclosure also extends to transportable power supply unit, comprising:

a load carrying support;
an electrical storage arrangement on the base;
at least one solar panel mounted on the load carrying support and electrically connected to the electrical storage arrangement; and
one or more electrical connectors for connecting electrical devices thereto for energizing the electrical device with electrical energy.

The electrical connectors may be cell phone chargers and/or power sockets for electrical devices.

The power supply unit may further include any one or more of the features of any of the preceding aspects of the disclosure described above.

According to yet another aspect of the disclosure there is provided a method of providing an electrical supply in a remote location including: transporting a power supply unit to the remote location and using it to provide electrical energy.

The power supply unit may include any one or more of the features of the power supply units defined in the preceding aspects of the invention.

In particular the load carrying support may be in accordance with any one or more of the power supply units as defined in any one of the preceding aspects of the invention.

If a mains power supply is interrupted as a result of a natural disaster people might not have an ability to charge their mobile telephones and smartphones. It would therefore be beneficial if a transportable power supply unit could be provided having a charging station or charger for charging a plurality of cell phones. The method and power supply unit described in the summary enable electrical power to be provided during a natural disaster.

### BRIEF SUMMARY OF THE DRAWINGS

A transportable power supply unit in accordance with this disclosure may manifest itself in a variety of forms. It will be convenient to hereinafter describe several embodiments of the disclosure in detail with reference to the accompanying drawings. The purpose of providing this detailed description is to instruct persons having an interest in the subject matter of the disclosure how to carry the invention into practical effect. However it is to be clearly understood that the specific nature of this detailed description does not supersede the generality of the preceding broad description. In the drawings:

FIG. 1 is a perspective view of a transportable power supply unit in accordance with one embodiment of the disclosure shown in a retracted configuration;

FIG. 2 is a front view of the transportable power supply unit in FIG. 1;

FIG. 3 is an upper perspective view of the transportable power supply unit in FIG. 1 shown in a deployed configuration;

FIG. 4 is an upper perspective view of a transportable power supply unit in accordance with another embodiment having two solar panels, shown in a deployed configuration;

FIG. 5 is a side view of the transportable power supply unit in FIG. 4;

FIG. 6 is a rear view of the transportable power supply unit in FIG. 5;

FIG. 7 is an upper perspective view of a transportable power supply unit in accordance with yet another embodiment;

FIG. 8 is a side view of the transportable power supply unit in FIG. 7;

FIG. 9 is a rear view of the transportable power supply unit in FIG. 7;

FIG. 10 is an upper perspective view of a transportable power supply unit in accordance with yet another embodiment of the disclosure;

FIG. 11 is a side view of the transportable power supply unit in FIG. 10;

FIG. 12 is an upper perspective view of a transportable power supply unit in accordance with yet another embodiment of the disclosure;

FIG. 13 is a side view of the transportable power supply unit in FIG. 10;

FIG. 14 is a perspective view of a transportable power supply unit in accordance with another embodiment having a cell phone locker;

FIG. 15 is a front view of a transportable power supply unit that is similar to that in FIG. 14;

FIG. 16 is a front view a transportable power supply unit having a power board with a bank of plug sockets for supplying electrical power to electrical appliances and devices;

FIG. 17 is a side view of a transportable power supply unit in accordance with another embodiment of the disclosure in which the unit is mounted on a trailer for transporting it from one location to another;

FIG. 18 is a rear perspective side view of the trailer of FIG. 17; and

FIG. 19 is a schematic view of a transportable power supply unit in accordance with another embodiment of the disclosure having an onboard water filter for filtering water.

### DETAILED DESCRIPTION OF EXAMPLE EMBODIMENTS

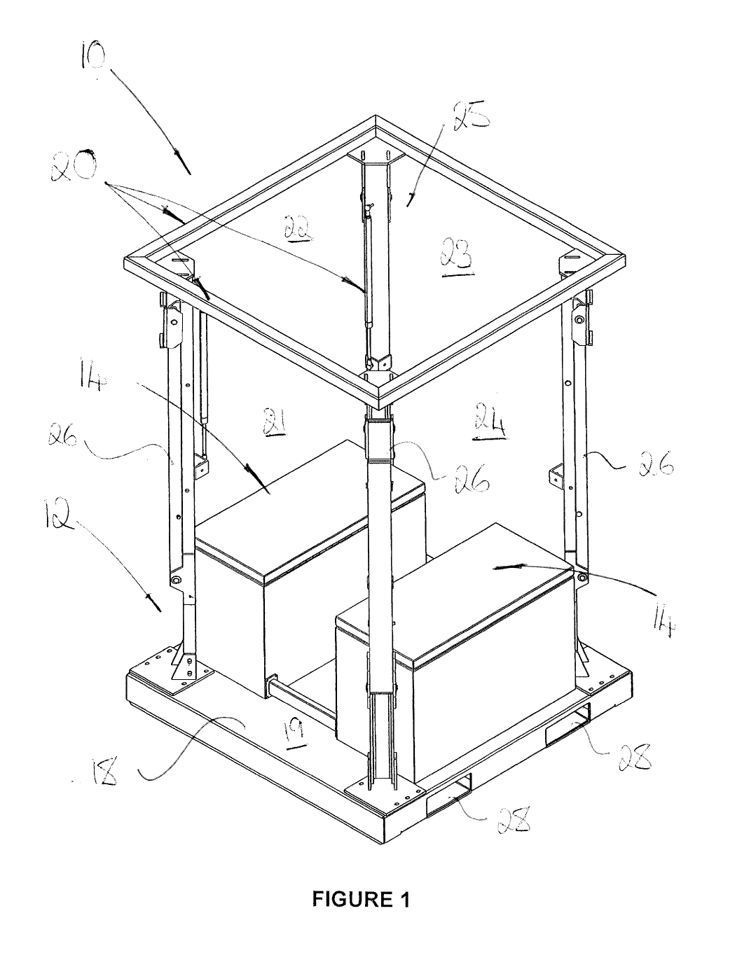

In FIGS. 1 to 3 reference numeral 10 refers generally to a transportable power supply unit in accordance with one embodiment of the disclosure.

The power supply unit 10 comprises broadly a load carrying support 12, and an electrical storage arrangement 14 mounted on the load carrying support 12.

The load carrying support 12 comprises a base 18 having an upward facing load support surface 19 that is substantially planar and a rectangular support frame 20 having four sides and a top projecting up from the support surface 19. The reference numerals 21, 22, 23, and 24 indicate the sides of the support frame and numeral 25 indicates the top of the frame 20. The support frame 20 is broadly co-extensive with the horizontal dimensions of the base which is also rectangular and has four sides corresponding to the four sides of the frame 20. Thus the edges of the base are broadly aligned with the sides. The support frame 20 is an open frame defining a three dimensional rectangular space above the rectangular support surface 19 of the base 18.

In the illustrated embodiment the base 18 is formed by a pallet which has a standard size and configuration. The pallet enables the unit 10 to be transported from one place to another using existing transport vehicles and infrastructure. The pallet 18 also has lifter engaging formations 28 in at least one side thereof for operatively receiving the forks of a forklift for lifting and lowering the load carrying support and thereby the entire power supply unit 10. This provides a way of generally handling the power supply unit 10 during transport from one location to another and generally setting up the unit 10 at a desired location and also removing it.

The electrical storage arrangement 14 comprises one or more batteries which in the illustrated embodiment is in the form of a plurality of battery packs. The battery packs 14 contain gel batteries that receive and store electrical energy from a solar regulator and can provide about 1.3 kW. The electrical storage arrangement includes vented and lockable battery boxes with heat shielding and a strong hold down system and also a shelf for internal equipment. The batteries supply this electrical energy to electrical devices and tools that consume electrical energy that will be described in more detail below. The portable electrical storage arrangement and battery pack may be used to produce AC or DC power.

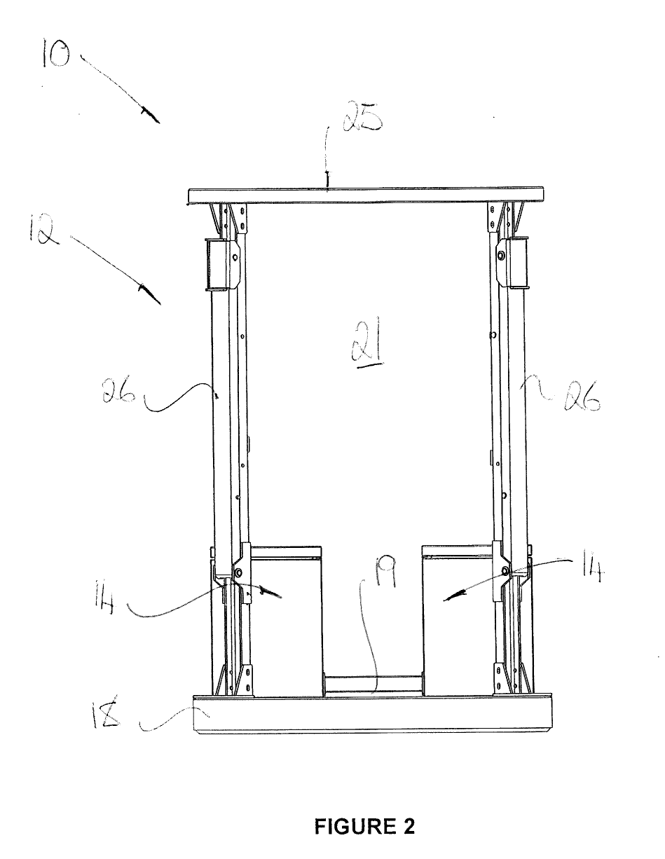

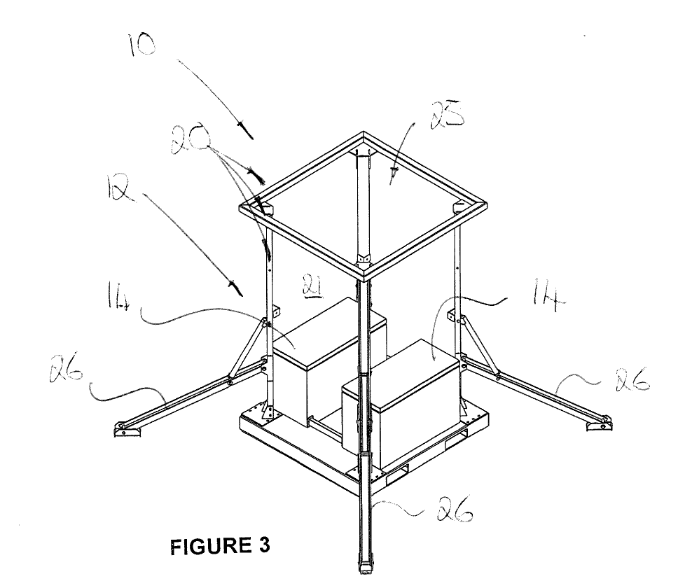

The power supply unit 10 further includes a plurality of stabilizer legs 26 mounted on the support frame 20 that project out from the support frame 20 for stabilizing the power unit 10 when it is positioned on a support surface such as the ground. The stabilizer legs 26 are interchangeable between a retracted position in which they lie up against the support frame 20 shown in FIGS. 1 and 2 and a deployed position shown in FIG. 3 in which they project outward away from the support frame 20 and engage the ground. In the illustrated embodiment the power unit 10 has four legs 26 namely one at each corner of the support frame 20. The stabilizer legs may fold down and out when the solar panels are deployed and include a foot that that is configured to grip the support surface, e.g. the ground.

In one form of this embodiment the unit includes solar panels (not shown) positioned at or about the support for providing electrical power to the unit.

However this embodiment is not limited to a power supply unit which generates electrical energy using solar energy.

In another form the embodiment utilizes electrical energy that is obtained in other ways and that is generated externally to the unit 10 and is not shown in the drawings. In this form the electrical power generation may be achieved by a diesel or petrol generator or in fact any other form of generator. While the generator has not been illustrated in the drawings its structure and function would be known to persons skilled in the art. The electrical power generator (not shown) adjacent the unit 10 would be operatively connected to the electrical storage arrangement 14 to charge the storage arrangement 14 with electrical energy.

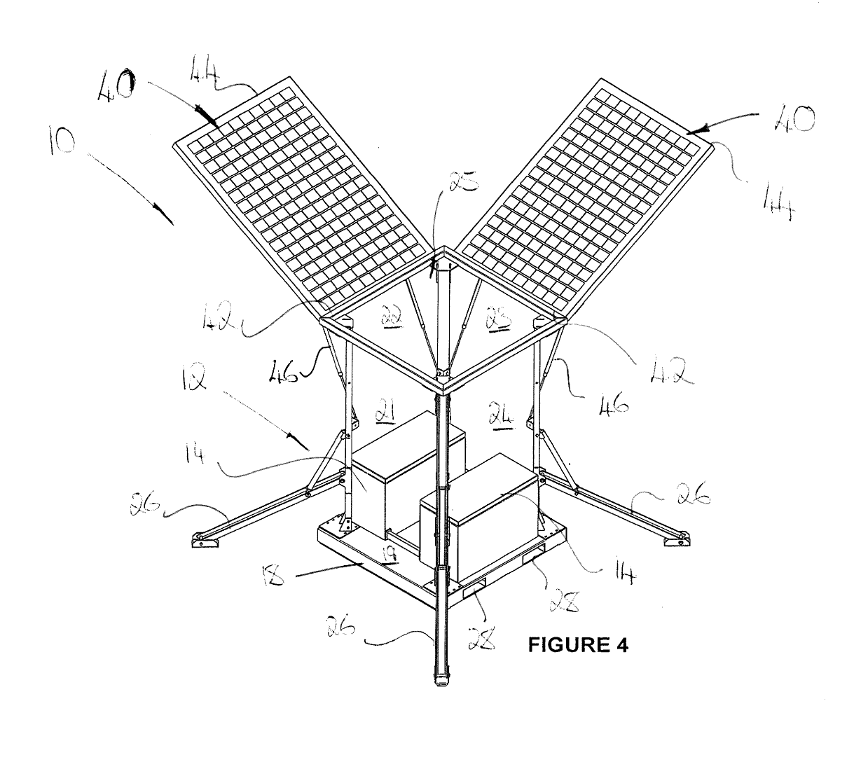

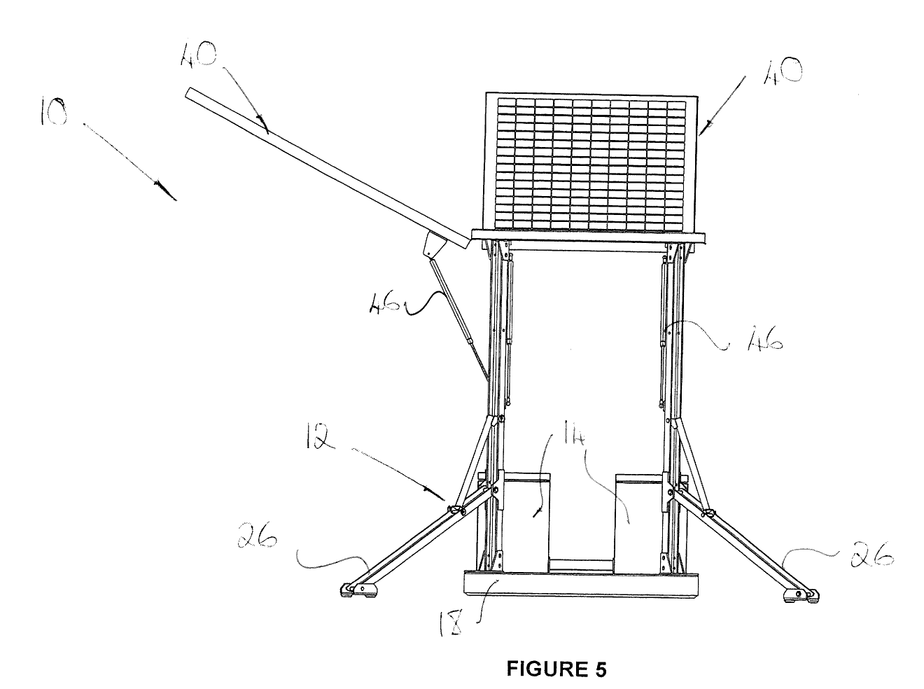

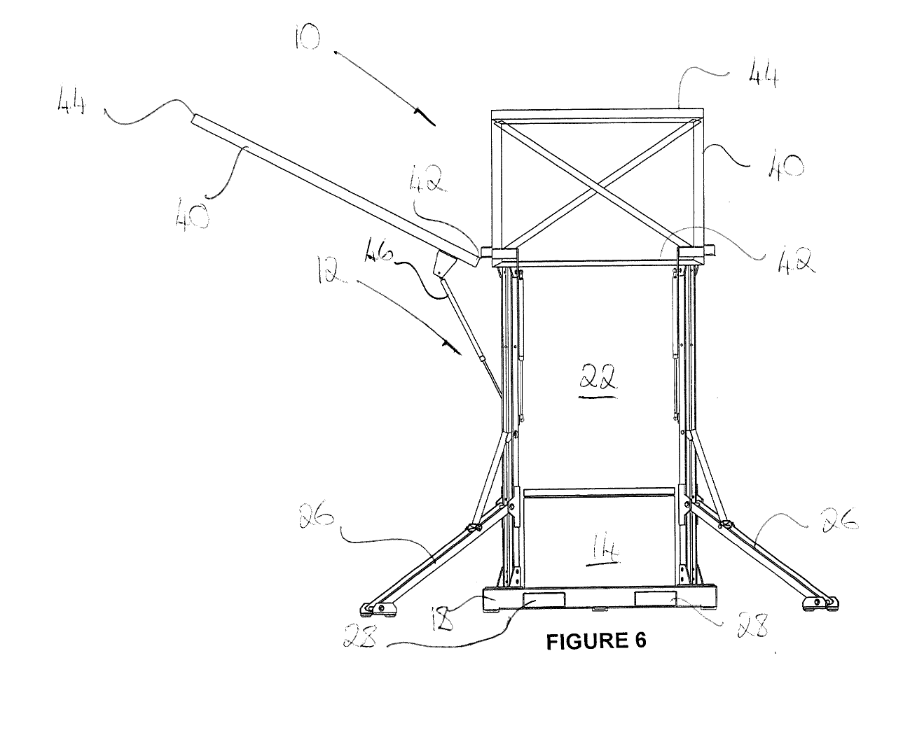

FIGS. 4 to 6 illustrate a power supply unit in accordance with another embodiment of the disclosure. This embodiment of the power supply unit is structurally and functionally similar to that described above with reference to FIGS. 1 to 3. Accordingly the same reference numerals will be used to refer to the same components unless otherwise indicated. Further the following description will focus on the main differences between this embodiment and the preceding embodiment.

The power supply unit 10 in these drawings has two solar panels 40 mounted thereon for collecting solar energy from the sun to charge the storage arrangement 14. This embodiment generates its own electrical energy and does not rely on a separate electricity generator.

Thus this embodiment is more independent and self-sustaining than an embodiment which relies on auxiliary electricity generation. The solar panels 40 are operatively connected to the electrical storage arrangement 14 on the base 18. In the illustrated embodiment the two solar panels 40 are mounted on adjacent orthogonally extending sides of the support frame 20 but they may equally be positioned on opposed sides of the support frame 20.

Each solar panel 40 is mounted on the support frame 20 extending across a side face of the frame 20. Each solar panel 40 has an operatively upper end 42 that is pivotally mounted to an upper edge of the support frame 20. Each solar panel 40 also has an opposed lower end 44 that can be pivoted away from the side of the support frame 20.

Further each solar panel 40 is interchangeable between a retracted configuration for transport not shown in which the solar panels 40 lie up against the associated side of the support frame 20, and a deployed configuration for receiving solar energy. As shown in FIGS. 4 to 6 of the drawings in the deployed configuration the panel 40 is pivoted through an obtuse angle of more than ninety degrees into the deployed configuration. Further each solar panel has at least one, e.g. two arms or stays 46 for supporting the solar panel in the outward extending deployed configuration. Each arm 46 extends between a post on the support frame 20 and the associated solar panel 40 and itself is interchangeable between a locked extended configuration and a folded configuration in which it does not support the solar panel 40.

The solar panels lock into place in their deployed configuration and can be arranged to provide optimal solar array positioning.

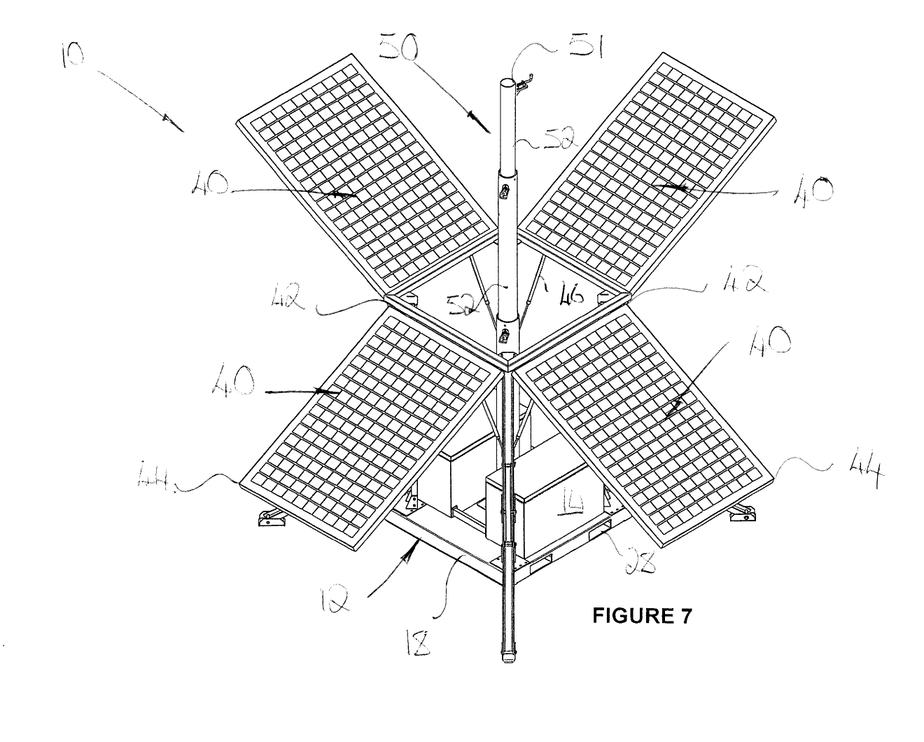

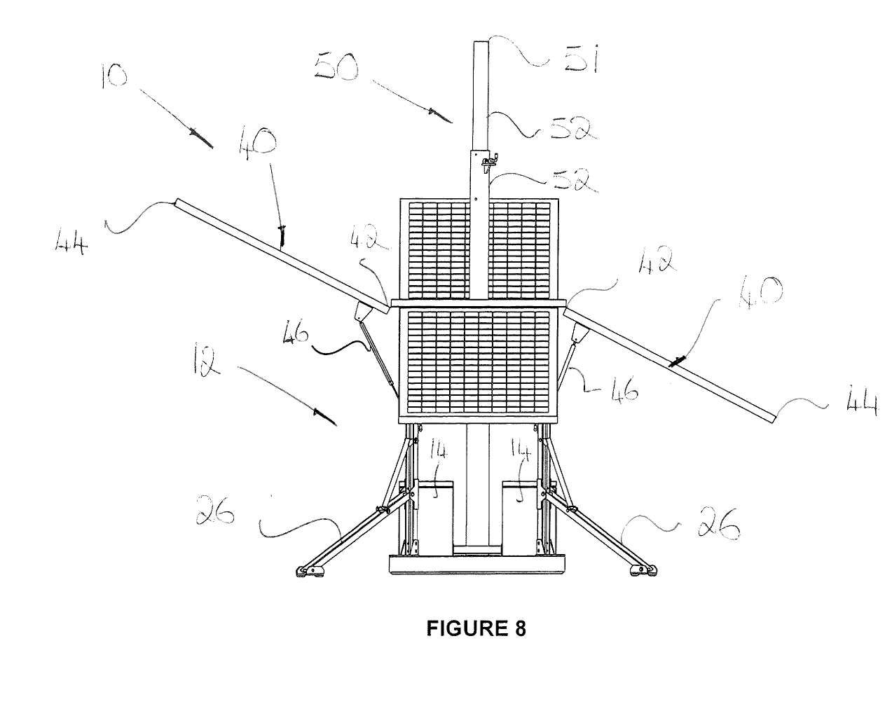

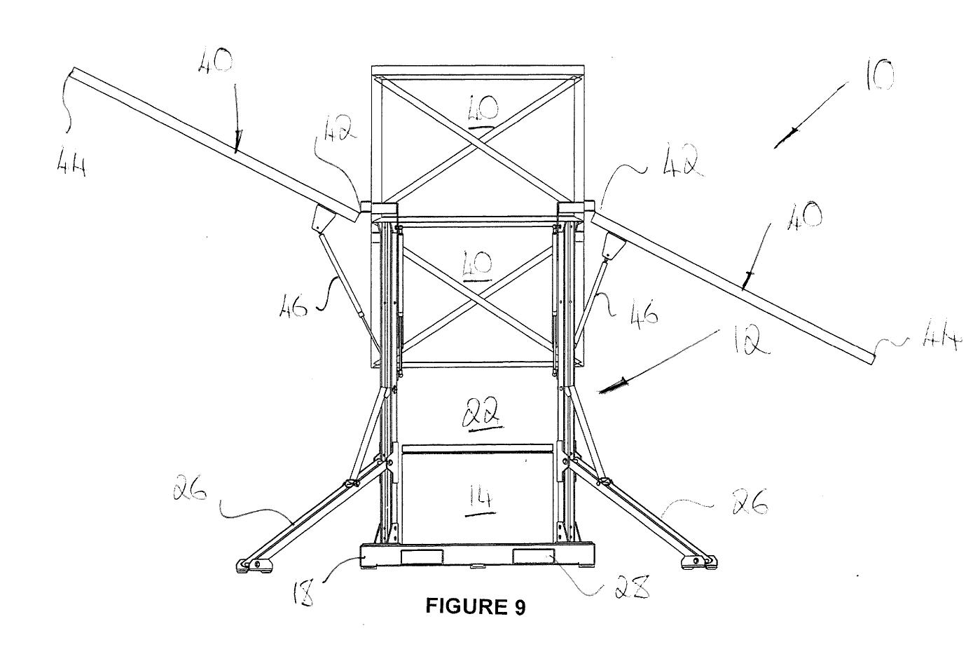

FIGS. 7 to 9 illustrate a power supply unit in accordance with another embodiment of the disclosure. This embodiment of the power supply unit is structurally and functionally similar to that described above with reference to FIGS. 1 to 3.

Accordingly the same reference numerals will be used to refer to the same components unless otherwise indicated.

Further following description will focus on the main differences between this embodiment and the preceding embodiment.

The embodiment of the power unit 10 in these drawings has four solar panels 40 instead of two as in the previous embodiment. The four solar panels 40 are mounted one each on a side 21 through to 24 of the support frame 20.

Each solar panel 40 is similarly mounted at its upper end 42 to the support frame 20 and can be pivoted outward relative to the frame where its end 44 is spaced away from the associated side of the frame 20, into a deployed configuration for collecting solar energy.

In this embodiment two adjacent solar panels 40 on sides 21 and 22 are pivoted through an obtuse angle into the deployed configuration and the other two solar panels 40 on sides 21, 23 are pivoted through an acute angle into the deployed configuration. The panels 40 are arranged in this way to enhance solar collection of the panels and the exact arrangement is decided upon based on the position of the sun relative to the power unit 10.

As shown in the drawings the solar panels can be arranged so as to enhance collection of solar energy from the sun when in their deployed configuration. This is shown most clearly in the FIG. 7 embodiment.

Two of the solar panels on adjacent sides of the frame are inclined down and outward and the other two solar panels are inclined up and outwardly. This way all four solar panels can be arranged to face towards the sun and enhance collection of solar energy from the sun. Naturally the panel support arrangement and in particular the support arms thereof are designed so that they can support the different solar panels on the unit in different orientations so as to enhance capture of solar energy from the sun. In particular the support arms may be capable of supporting each solar panel in one orientation where the panel extends downward and outward from the support frame in the deployed configuration, and another orientation where the panel extends upward and outward away from the support frame in the deployed configuration.

In one embodiment in particular having four solar panels, two adjacent panels extend downward and outward from the support frame and the other two adjacent panels extend upward and outward from the support frame such that all the solar panels face in the same general direction.

Further this FIG. 7 embodiment includes a post 50 mounted on a central position on the surface 19 of the base 18 and projecting up therefrom. The post 50 is interchangeable between a retracted position and an extended position. In the retracted position the post 50 is received within an interior space defined by the support frame 20 suitable for transport and handling (not shown in the drawings).

By contrast in the extended position the post 50 projects upward above the support frame 20. In the illustrated embodiment that post 50 has a number of telescoping post sections 52 that can be displaced relative to each other to extend the post 50 into an extended position in which it projects up above the support frame 20.

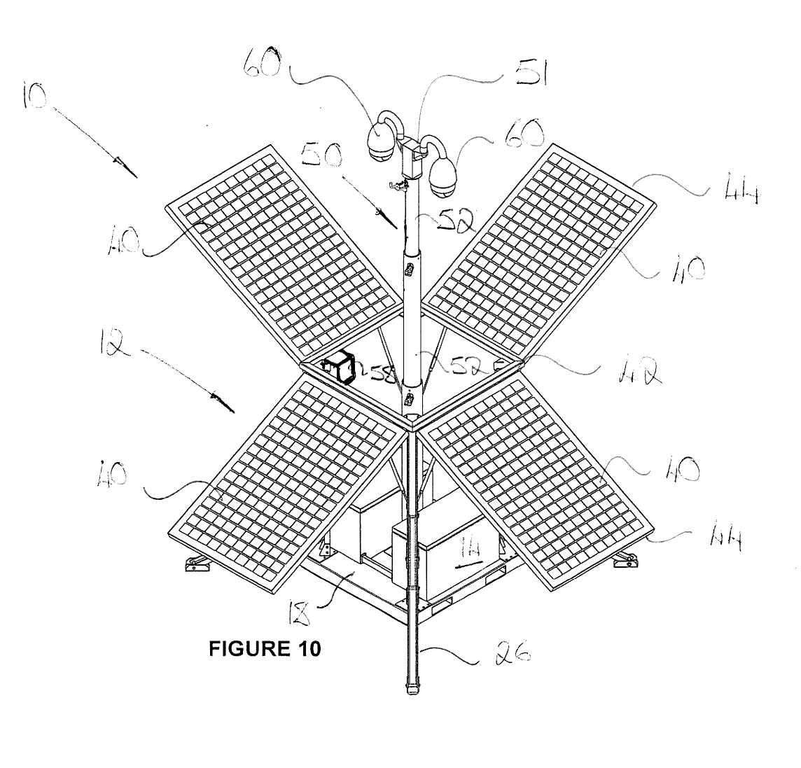

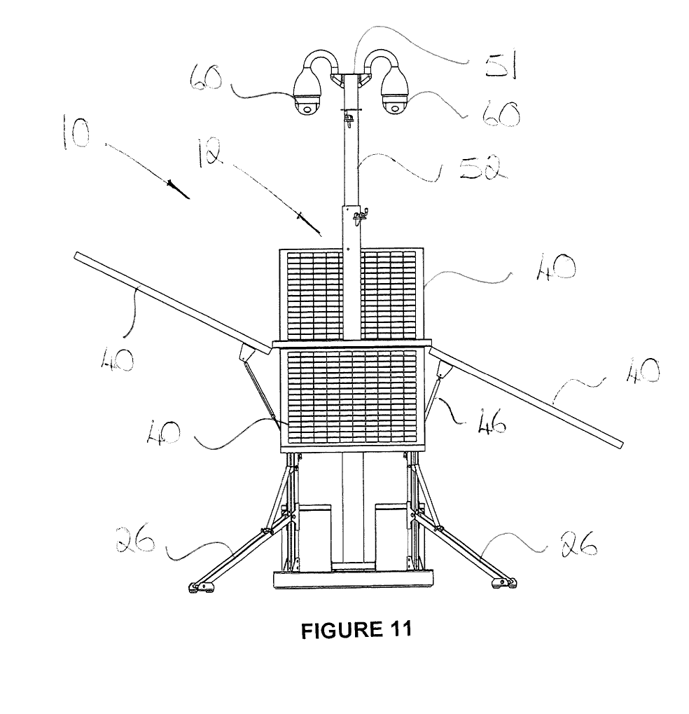

FIGS. 10 and 11 illustrate a power supply unit in accordance with yet another embodiment of the disclosure. This embodiment of the power supply unit is structurally and functionally similar to that described above with reference to FIGS. 7 to 9. Accordingly the same reference numerals will be used to refer to the same components unless otherwise indicated and the following description will focus on the main differences with this embodiment.

In this embodiment the power unit 10 has two cameras 60 mounted on an upper end 52 of the central post 50. The post 50 is shown in the extended position in which it extends up to a height well above the support frame 20. Thus the cameras 60 are positioned at a height that gives good surveillance of a surrounding area.

Typically the cameras 60 are used for security purposes and record moving visual images, e.g. like video images, of a surrounding area. The cameras 60 may be set up to film and record continuously and retain filmed material for at least a couple of weeks in a way that is known in the art of security cameras. The cameras 60 will typically be purchased off the shelf and the structure and function of the cameras 60 do not form part of the disclosure. Accordingly they will not be described further in this specification.

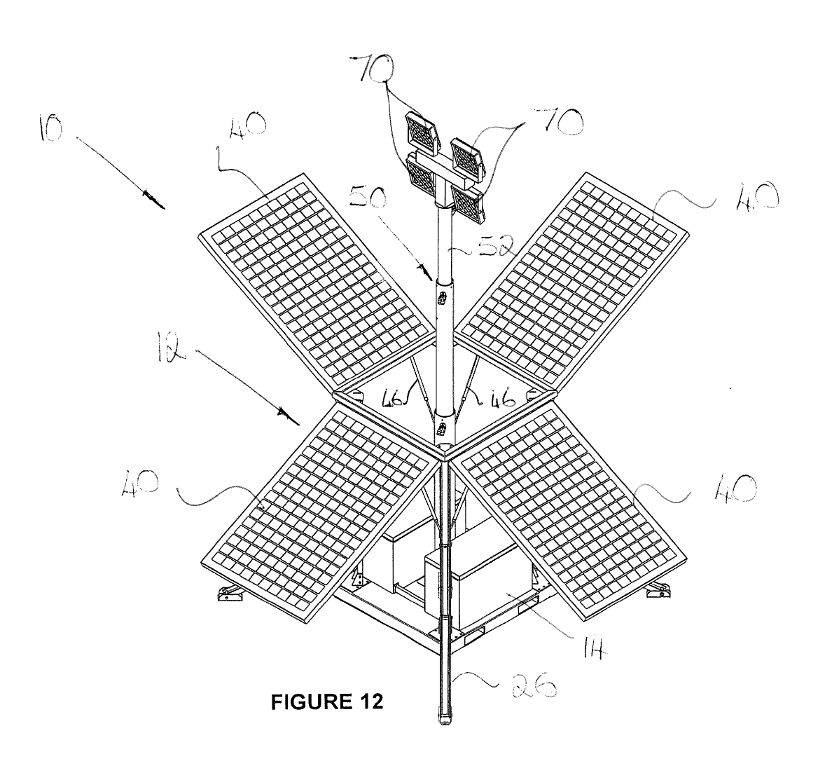

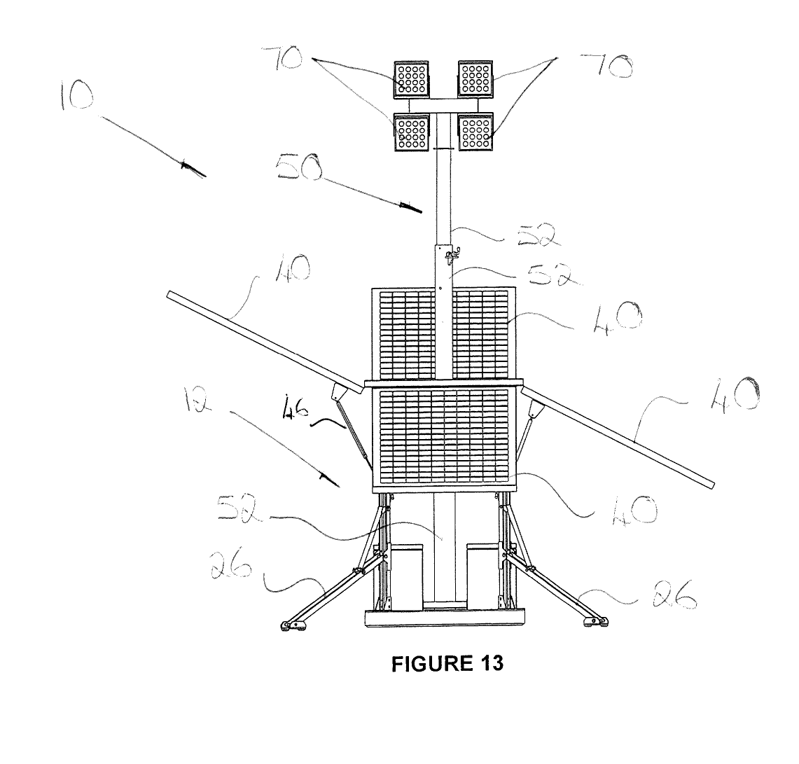

FIGS. 12 and 13 illustrate a power supply unit in accordance with yet another embodiment of the disclosure. This embodiment of the power supply unit is structurally and functionally similar to that described above with reference to FIGS. 7 to 9. Accordingly the same reference numerals will be used to refer to the same components unless otherwise indicated and the following description will focus on the main differences with this embodiment.

In this embodiment the power unit 10 has four lights 70 mounted on an operatively upper end 51 of the central post 50. The four lights 70 are electrically connected to the battery packs 14 on the base 18 and are energized by electrical energy from the batteries. The lights 70 are LED lights which use less electrical power than filament light bulbs and also last longer than filament light bulbs. In the illustrated embodiment the lights 70 are arranged so they face in the same direction. However it will be readily appreciated that other orientations of the lights 70 could equally be chosen.

Further in each of the embodiments described above with reference to FIGS. 1 to 13, the transportable power supply unit further includes a communications arrangement including a communications hardware module for enabling an operator to monitor the unit remotely. In the illustrated embodiments the communications arrangement also enables an operator to remotely control the power supply unit (as well as monitor it).

The communications module includes a housing mounted on the frame that includes hardware, e.g. including a modem or router, for enabling an operator to communicate with the unit from a remote location using wireless networks. The communications module is shown in FIG. 10 where it is indicated by reference numeral 58 but is not shown in all the drawings. In the other drawings this module 58 is mounted on the support frame in a similar way to that shown in FIG. 10 but has been omitted from the drawings for clarity. The wireless networks may include mobile telephone networks such as 3G and 4G networks. Optionally also if the unit 10 is at a very remote location outside of network coverage for the mobile networks then a satellite telephone phone network can be used.

In use this enables an operator to monitor and control the power supply unit 10 remotely. For example the images recorded by a security camera can be transmitted to a control location where they can be surveyed and reviewed if necessary. Further if one of the functional units on the power supply unit 10 is not functioning correctly this can be noted and remedial action can be taken. For example if a camera is not functioning correctly it can signal this to a controller at a remote location. Further if a light fails this can be signaled to the controller at a remote location and the light can be de-activated.

By way of an example of an application of the power supply unit 10, if a mains power supply is interrupted as a result of a natural disaster people might not have an ability to charge their mobile telephones and smartphones. The transportable power supply unit can be provided having a charging station for charging a plurality of cell phones.

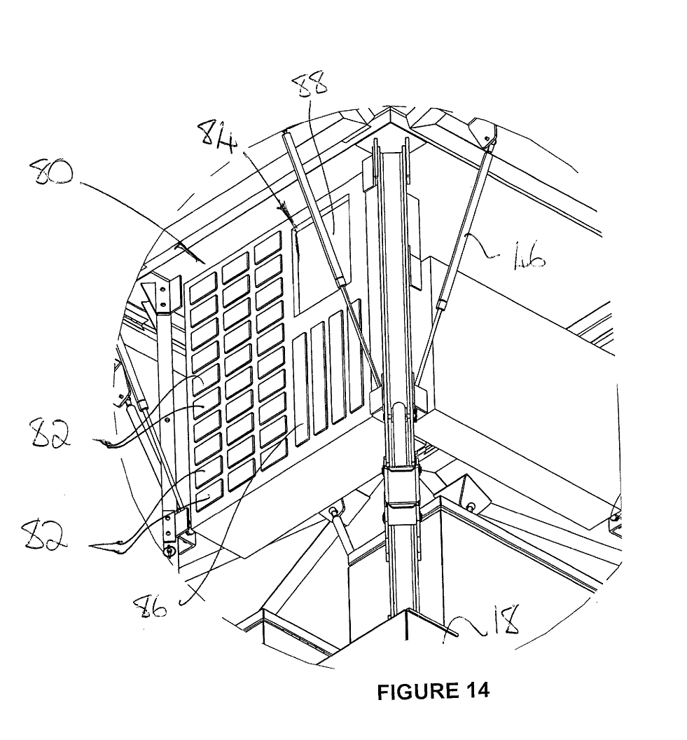

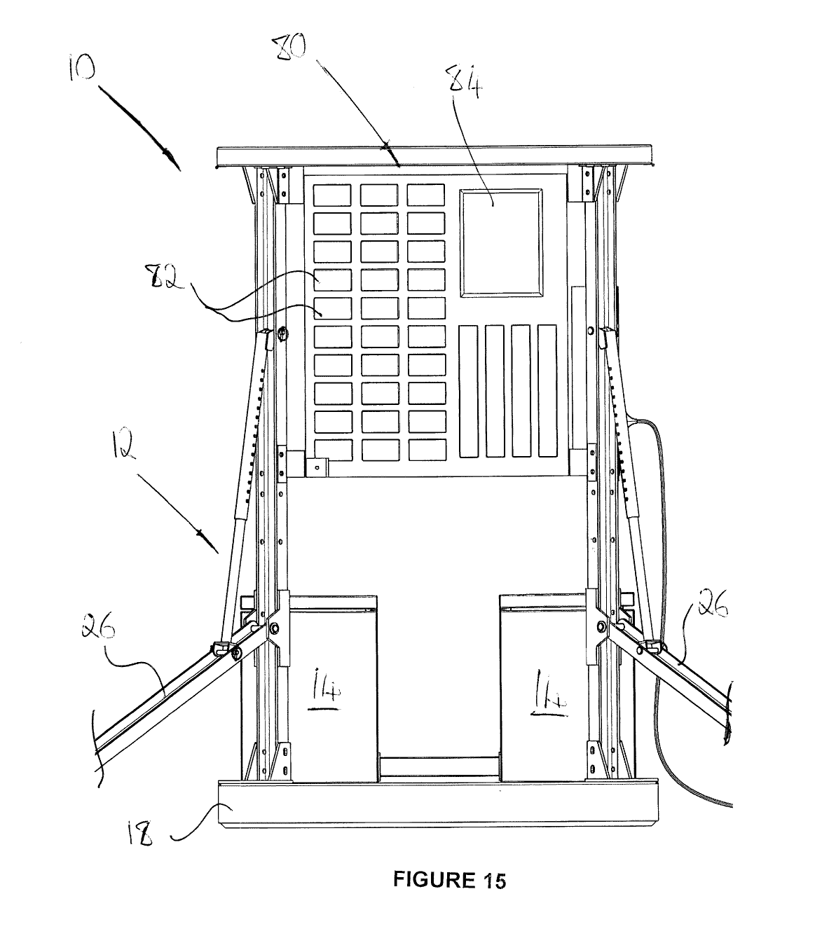

FIGS. 14 and 15 illustrate a power unit in accordance with yet another embodiment of the disclosure. FIG. 14 illustrates an overview of the power unit and as shown in the drawings this embodiment has some similarities with the embodiment in FIG. 7.

In particular it has a series of four solar panels 40 arranged one each on the sides 21, 22, 23, and 24 of the support frame 20.

The power supply unit 10 in this embodiment includes a support 14, and an electrical storage arrangement comprising two battery packs 14 on the support 12 as for the previous embodiments. The support 12 comprises a base 18 and a support frame 20 mounted on and projecting up from the base 18.

The power supply unit 10 also includes a bank of cell phone lockers 80 mounted on the support frame 20, e.g. at a height above the battery packs 14. The bank of cell phone lockers 80 comprises an array of lockers 82 each of which has a charger (not shown) for charging a cell phone. Each cell phone charger is electrically connected to the battery packs to provide electrical energy for the charging stations.

Each cell phone locker 82 in turn comprises a container that can be opened to insert a cell phone and closed to enclose the cell phone therein while it is being charged. Further the cell phone container is lockable to resist unauthorized removal of a cell phone from the container.

In the illustrated embodiment the bank of cell phone lockers has a user interface for enabling each user of a locker to securely lock their cell phone away and then unlock the locker to retrieve the cell phone once it is charged. The user interface comprises a key pad and a display screen, which together enable a user to key in a code and lock and unlock their locker.

FIG. 15 shows a power supply unit with a bank of cell phone lockers. However in this embodiment the cell phone lockers are outward facing. This enables the cell phone lockers to be accessed from outside of the unit 10 which may be easier particularly if there are several people using it. Other than this the structure and function of this embodiment is similar to that described above.

In use, in a remote location where mains power is not readily available it may be desirable to charge a cell phone which is running low on power. This is particularly the case in an area where electrical power supply has been interrupted. The power unit 10 can be set up in a central location and people can come and use the cell phone lockers 82 to charge their cell phones. To do this they place their phone in a locker and operatively plug it into the charger. The locker is closed and locked and the user can leave the vicinity of the power unit. After a suitable length of time for the phone to charge, the user returns to the power unit and unlocks their locker and withdraws their phone.

In the current age of smartphones a phone enables a user to carry out many tasks provided they have a charged phone and a network reception. In particular they are able to communicate with the outside world and with each other and send emails, access social media and make phone calls and send text messages. This highlights the importance of providing the ability for people to charge their phones when mains power is interrupted.

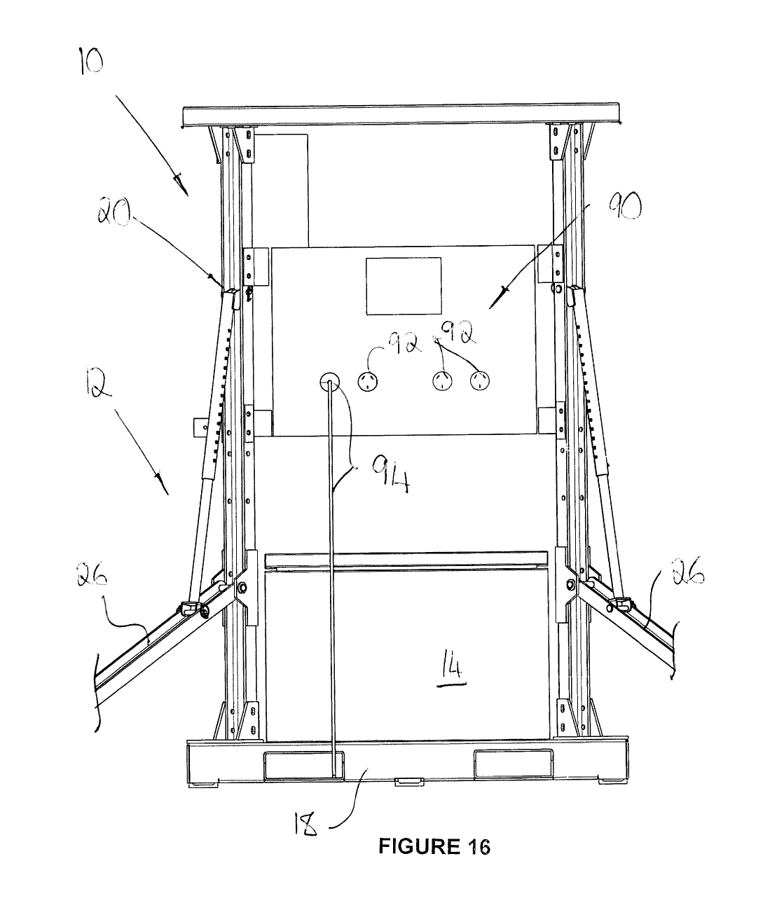

FIG. 16 illustrates a transportable power supply unit in accordance with another embodiment of the disclosure.

In this embodiment the unit 10 includes a power board 90 with a plurality of electrical sockets 92 for receiving electrical plugs, an example of which is shown as 94 on the power board 90. The power board 90 is electrically connected to the battery packs 14 on the unit 10. This enables a user to plug a power cord 94 of an electrical device into a socket 92 to obtain electrical power to run the device. Typically the power will be at the same voltage as mains power, e.g. 220-230 volts in Australia, to run devices that are normally plugged into mains sockets.

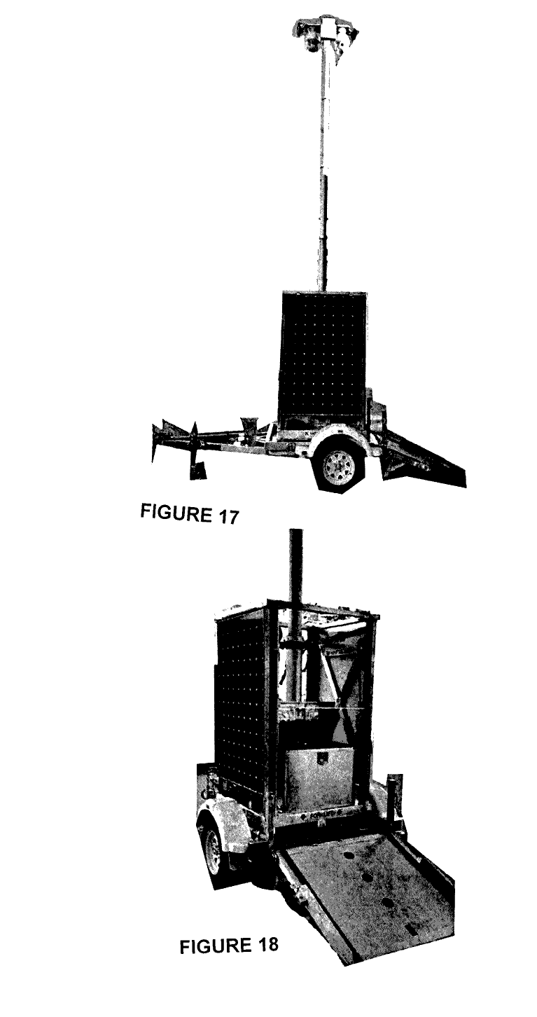

FIGS. 17 and 18 illustrate a transportable power supply unit that is mounted on a trailer. This embodiment is quite similar to the embodiments discussed above with reference to FIGS. 4 to 6. Accordingly unless otherwise indicated the same reference numerals will be used to refer to the same components unless otherwise indicated. Further the following description will focus on the main differences between this embodiment and the FIG. 4 embodiment discussed above.

The power supply unit 10 is mounted on a trailer that can be towed by a towing vehicle on the road. The trailer is small and compact and can be operatively coupled to a tow hitch of a tow vehicle by means of a HAYMAN-REECE coupling. This enables the unit 10 to be easily and conveniently towed by a vehicle to a rural or remote location where it is required. The unit on the trailer can be towed by a normal road going vehicle driven on a car license.

Further the embodiment shown in FIGS. 17 and 18 also includes a centrally mounted post on the base. The post is telescopically extendible between a retracted position for travel and an extended position for use or deployment. In the illustrated embodiment video cameras are mounted on the top of the post for carrying out surveillance of an area. Alternatively lights could also be mounted on the central post.

When the unit 10 arrives at the location where it is to be used the trailer is uncoupled from the tow vehicle and is steadied on the ground by the tow bar and jockey wheel on one side and a lowered tail gate on an opposite side. Further additional stabilizer legs may be provided to stabilize the trailer when deployed if required.

The illustrated embodiment has two solar panels mounted thereon. The solar panels can be moved to the deployed position by pivoting them outward to the position shown in FIGS. 4 and 7 of the drawings. Thereafter the central post is extended to its extended position for deployment.

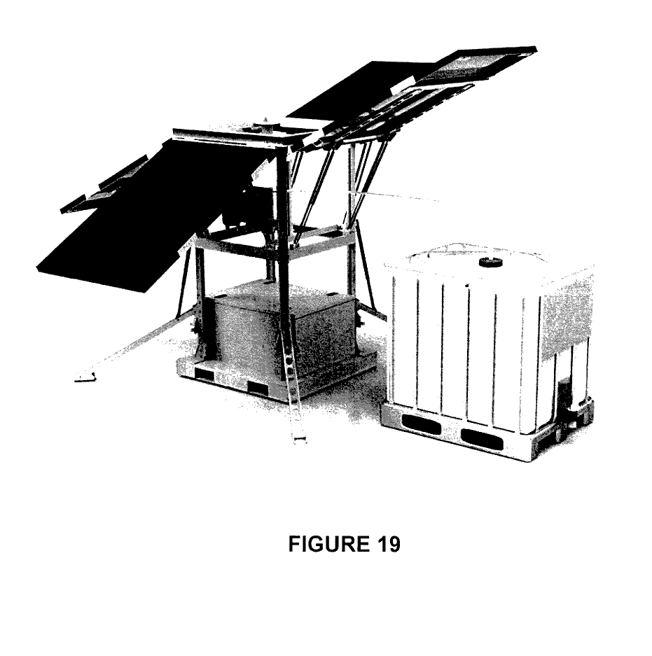

FIG. 19 shows a transportable power supply unit having an onboard water filter for filtering water. This embodiment has similarities with the preceding embodiments and the same reference numerals will be used to refer to the same components unless otherwise indicated.

The power unit in FIG. 19 includes a water filter having a filter housing mounted on the load carrying support. The housing projects up above the base into the three dimensional space defined by the support frame 20. The unit also includes a water pump, e.g. a centrifugal pump, mounted on the base that is operatively connected to the water filter. The water pump is positioned upstream of the water filter and drives the water through the water filter. The water pump is operatively connected to the electrical storage arrangement or battery pack to provide the electrical energy to drive the pump.

The filter is operatively coupled to a storage tank positioned adjacent to the power supply unit and filtered water is discharged into the tank where it is stored.

In use water is drawn from a water source of untreated water and is pumped through the water filter. The filtered water is collected on the downstream side of the water filter in the water tank where it is stored for use. The water can then be used for drinking water. The tank has a tap on its side for drawing off filtered water when it is needed.

Generally the power supply unit described in at least some of the embodiments above is a fully self-contained portable power platform in particular for transportable applications where AC or DC power is required in remote locations. The unit can be deployed in several minutes once on site and can be used immediately to supply about 1.3 kW of power. The rugged construction, e.g. of aluminum, requires no maintenance or painting and is built to withstand harsh weather and climactic conditions. The transportable power supply unit is particularly suitable for defence applications, and mining and agricultural applications in particular.

An advantage of the power supply unit described above with reference to FIGS. 4 to 15 is that it is capable of generating electrical energy from solar energy. It can store the electrical energy in battery packs mounted on the unit and can then use this electrical energy to power a number of electrical services including lights and security cameras. It also has a bank of power supply sockets which can be used to power or charge a range of electrical appliances.

Another advantage of the power supply unit described above with reference to FIGS. 4 to 15 is that the load carrying support has a rectangular frame and solar panels can be mounted on two or more sides of the support for collecting solar energy and feeding it into the battery pack. Further the solar panels can be interchanged between a retracted configuration in which they lie up against a side of the frame and do not project outward therefrom and an expanded configuration in which they are pivoted away from the side of the frame and orientated in a favorable position to catch the sun's rays.

Another advantage of the power supply unit described above with reference to FIGS. 4 to 15 is that it has a central post which can be extended up to a substantial height thereby providing a suitable mounting for a security camera or a light and in particular a security light. At the same time the post can be retracted inward so that it is received within the interior space of the load carrying support for transport and the like.

Another advantage of the power supply unit described above with reference to FIGS. 4 to 15 is that the base of the load carrying support may be a basic pallet. This enables the power unit to be handled, loaded and transported in the same way as a pallet. This enables standard transport equipment and infrastructure to be used for this purpose. Further if a larger power supply unit is required than can be provided by a single pallet a plurality of pallets can be connected to each other to create a larger base.

It will of course be realized that the above has been given only by way of illustrative example of the invention and that all such modifications and variations thereto, as would be apparent to persons skilled in the art, are deemed to fall within the broad scope and ambit of the invention as is herein set forth.

1. A transportable power supply unit, comprising:
a load carrying support;
an electrical storage arrangement on the load carrying support; and
at least two solar panels operatively mounted on the load carrying support that are operatively connected to the electrical storage arrangement, and each solar panel is interchangeable between a retracted configuration for transport and a deployed configuration for receiving solar energy.

2. A transportable power supply unit according to claim 1, wherein the load carrying support includes a base, and a support frame projecting up above the base having a plurality of sides.

3. A transportable power supply unit according to claim 2, wherein the support frame is in the form of a three dimensional rectangular frame having four sides.

4. A transportable power supply unit according to claim 2, wherein each solar panel is mounted on the support frame and extends across one side of the frame.

5. A transportable power supply unit according to claim 4, wherein each solar panel is arranged in the same plane as its associated side of the support frame in the retracted configuration, and each panel is inclined outward relative to the associated side of the frame in the deployed configuration.

6. A transportable power supply unit according to claim 5, wherein each panel has an inner end pivotally mounted to the support frame and an outer end that is displaced outward relative to the support frame in the deployed configuration to enhance its collection of solar energy.

7. A transportable power supply unit according to claim 5, wherein each solar panel includes a panel support arrangement for supporting the solar panel on the support frame in the outwardly extending deployed configuration in the form of one or more support arms extending between the support frame and the associated solar panel.

8. A transportable power supply unit according to claim 5, further including at least two stabilizer legs mounted on the load carrying support for stabilizing the support in position on a support surface when the solar panels are in the deployed configuration.

9. A transportable power supply unit according to claim 8, wherein each support leg is interchangeable between a stowed configuration in which the leg is folded up against the support frame and a deployed configuration in which the leg projects away from the support frame and onto the support surface.

10. A transportable power supply unit according to claim 2, wherein the transportable power supply unit further includes a post that is mounted on the base and projects upward therefrom, and the post is extendible between a collapsed configuration for transport in which it is received within the support frame and an extended configuration in which it projects upward above the support frame.

11. A transportable power supply unit according to claim 10, wherein the transportable power unit includes at least one camera mounted on the post for recording visual images within its field of view, and the camera is a digital camera recording moving pictures or video.

12. A transportable power supply unit according to claim 10, further including at least one light mounted on the post for illuminating an area for surveillance.

13. A transportable power supply unit according to claim 2, wherein the base is formed by a pallet, and the pallet has lifter engaging formations for operatively engaging a lifter for generally handling the power supply unit and lifting and lowering the power supply unit.

14. A transportable power supply unit according to claim 10, further including a road trailer having a deck and mounted on wheels, and wherein the load carrying support is positioned on the deck of the trailer.

15. A transportable power supply unit according to claim 2, wherein the electrical storage arrangement comprises at least one battery pack mounted on the base that is electrically connected to the solar panels.

16. A transportable power supply unit according to claim 1, including a water filter for filtering water to produce filtered water and a water pump for driving water through the filter, wherein the filter and the water pump are mounted on the load carrying support and the water pump is connected to the electrical storage arrangement.

17. A transportable power supply unit according to claim 1, including an electrical power board mounted on the load carrying support that is electrically connected to the electrical storage arrangement, and the electrical power board has a plurality of power sockets thereon into which electrical devices can be plugged.

18. A transportable power supply unit according to claim 1, further including a plurality of cell phone chargers mounted on the load carrying support that are electrically connected to the electrical storage arrangement, and wherein the plurality of cell phone chargers are incorporated in a bank of cell phone lockers having security features that enable them to be locked by a user.

19. A transportable power supply unit according to claim 1, further including a unit communications arrangement for enabling an operator to monitor the unit from a location remote from the unit using a wireless network, and wherein the communications arrangement further permits an operator to control the power supply unit from a remote location.

20. A transportable power supply unit, comprising:
a trailer mounted on wheels;
a load carrying support mounted on the trailer or formed by the trailer;
an electrical storage arrangement on the load carrying support; and
at least two solar panels operatively mounted on the load carrying support that are operatively connected to the electrical storage arrangement, each solar panel being interchangeable between a retracted configuration for transport and a deployed configuration for receiving solar energy.
